(19) United States
(12) Patent Application Publication
(10) Pub. No.: US 2004/0253344 A1
(43) Pub. Date: Dec. 16, 2004

(54) Dairy product comprising hyaluronic acid

(75) Inventor: Henrik Dalboge, Virum (DK)

Correspondence Address: NOVOZYMES NORTH AMERICA, INC., 500 FIFTH AVENUE, SUITE 1600, NEW YORK, NY, 10110, US

(73) Assignees: Novozymes A/S, Bagsvaerd (DK); Chr. Hansen, A/S, Hoersholm (DK)

(21) Appl. No.: 10/817,694

(22) Filed: Apr. 2, 2004

Related U.S. Application Data
(60) Provisional application No. 60/463,091, filed on Apr. 15, 2003.

(30) Foreign Application Priority Data
Apr. 11, 2003 (DK) 2003 00576

(51) Int. Cl. A23C 9/12

(52) U.S. Cl. 426/34

(57) ABSTRACT

Hyaluronic acid has been found to improve the texture and/or mouthfeel of dairy products and accordingly the present invention relates to a dairy product comprising hyaluronic acid, a method of producing a dairy product and use of hyaluronic acid for producing a dairy product.

### CROSS-REFERENCE TO RELATED APPLICATIONS

This application claims priority under 35 U.S.C. 119 of Danish application PA 2003 00576 filed Apr. 11, 2003 and the benefit of U.S. Provisional application No. 60/463,091, filed Apr. 15, 2003, the contents of which are fully incorporated herein by reference.

### TECHNICAL FIELD

The present invention relates to a dairy product comprising hyaluronic acid, a method of producing the dairy product, and use of hyaluronic acid for producing a dairy product.

### BACKGROUND OF THE INVENTION

Glycosaminoglycans such as hyaluronic acid are negatively charged molecules, and have an extended conformation. Glycosaminoglycans are located primarily on the surface of cells or in the extracellular matrix. Glycosaminoglycans also have low compressibility in solution. As such, glycosaminoglycans are ideal as a lubricating fluid, and are found naturally in the joints. The rigidity of glycosaminoglycans provides structural integrity to cells and provides passageways between cells, allowing for cell migration.

Hyaluronic acid is also suspected of having a role in numerous physiological functions, such as adhesion, development, cell motility, cancer, angiogenesis, cartilage enhancement and wound healing.

U.S. Pat. No. 6,432,929 discloses a cartilage enhancing food supplement comprising hyaluronic acid.

In dairy products the texture, mouthfeel and stability may be enhanced by addition of texturising agents. These agents typically bind water and/or increase the viscosity of the product. Texturising agents may also be used to replace fat in low fat dairy products. Examples of texturising agents are gelatine and pectin.

It is an object of the present invention to provide a dairy product with health benefits and/or enhanced textural properties.

### SUMMARY OF THE INVENTION

The inventors have found that hyaluronic acid affects the textural properties of a dairy product, especially the viscosity and gel stiffness is increased.

The invention thus relates in a first aspect to a dairy product comprising hyaluronic acid and one or more milk components.

In a second aspect the invention relates to a method for producing a dairy product comprising adding hyaluronic acid to a dairy composition.

In a further aspect the invention relates to use of hyaluronic acid for producing a dairy product.

### DETAILED DESCRIPTION OF THE INVENTION

Hyaluronic Acid

In the context of the present invention the term “hyaluronic acid” covers hyaluronic acid as such as well as a salt of hyaluronic acid, a hyoluronate.

Hyaluronic acid is an unsulphated glycosaminoglycan with a simple structure of repeating disaccharide units of N-acetyl-glucosamine and D-glucuronic acid. The sugars are linked together by alternating beta-1,4 and beta-1,3 glycosidic bonds. Hyaluronic acid has a molecular weight usually in the range from about 100 kDa to about 3000 kDa.

In one embodiment of the invention the amount of hyaluronic acid in the dairy product is an amount sufficient to achieve the desired effect on the texture and/or the desired health benefit of the dairy product. In a preferred embodiment of the invention the dairy product comprises hyaluronic acid in an amount sufficient to affect the texture of the dairy product compared to the dairy product without hyaluronic acid, such as in an amount sufficient to increase the viscosity and/or gel stiffness of the dairy product. The amount will usually be in the range 0.001-10% (weight/weight), such as in the range 0.005-5%, preferably in the range 0.01-2%, more preferably in the range 0.01-1%.

Sources of Hyaluronic Acid

A main commercial source of hyaluronic acid is chicken or rooster comb, which has hyaluronic acid at a higher concentration than other animal tissues. Another important source of hyaluronic acid is microorganisms, through a fermentation process. U.S. Pat. No. 4,801,539, (Akasaka, et al.) discloses a method for preparing hyaluronic acid. Yields from a strain of S. zooepidemicus are reported of about 3.6 g/l. In European patent EP0694616, yields of about 3.5 g/l are reported from fermentation processes using an improved strain of S. zooepidemicus.

In a preferred embodiment of the invention hyaluronic acid is in the form of a salt of hyaluronic acid, a hyaluronate, such as e.g. sodium hyaluronate, or calcium hyaluronate.

Hyaluronic acid according to the invention may be from any source known in the art, such as e.g. from rooster or chicken comb or from a microorganism. In a preferred embodiment hyaluronic acid is produced by a microorganism, such as e.g. by a strain of Streptococcus, such as e.g. S. zooepidemicus, a strain of Pasteurella, such as e.g. P. multocida, or a strain of Bacillus.

Dairy Composition

A dairy composition according to the invention may be any composition comprising, or consisting of, one or more milk components and/or milk fractions. A milk component may be any component of milk such as e.g. milk fat, milk protein, casein, whey protein, or lactose. A milk fraction may be any fraction of milk such as e.g. skimmed milk, butter milk, whey, cream, milk treated by ultrafiltration, milk powder, whole milk powder, or skimmed milk powder. In a preferred embodiment of the invention the dairy composition comprises milk, skimmed milk, butter milk, whole milk, cream, or any combination thereof. In a more preferred embodiment the dairy composition consists of milk, such as skimmed milk, whole milk, cream, or any combination thereof.

In further embodiments of the invention, the dairy composition is prepared, totally or in part, from dried milk fractions, such as, e.g., whole milk powder, skimmed milk powder, casein, caseinate, whey powder, whey protein isolate, whey protein concentrate, total milk protein, buttermilk powder, or any combination thereof.

In the present context milk may be the lacteal secretion of any mammal. Thus, milk may be obtained by milking, e.g., cows, sheep, goats, buffaloes, or camels.

The dairy composition may be heat treated by pasteurisation, sterilization or treated in any other appropriate way. The pasteurisation and sterilization procedures may be any such procedure known in the art. The dairy composition may further be homogenised by methods known in the art.

In one embodiment of the invention hyaluronic acid is added to a dairy composition. The resulting mixture may be processed further into a dairy product. Hyaluronic acid may be added to the dairy composition at any appropriate step in the manufacturing of the dairy product. If the dairy composition is heat treated, hyaluronic acid may be added before or after the heat treatment. If the dairy product is fermented hyaluronic acid may be added before, during, or after fermentation. In one embodiment hyaluronic acid is mixed into the finished dairy product. Hyaluronic acid may be added in pure form or mixed with other substances. In a preferred embodiment hyaluronic acid is added as an aqueous solution or dispersion of hyaluronic acid. In another preferred embodiment hyaluronic acid is mixed with sugar and/or milk powder before addition to the dairy composition. In one embodiment of the invention the amount of hyaluronic acid added to the dairy composition is an amount sufficient to achieve the desired effect on the texture and/or the desired health benefit of the dairy product. In a preferred embodiment of the invention hyaluronic acid is added in an amount sufficient to affect the texture of the dairy product compared to the dairy product without hyaluronic acid, such as in an amount sufficient to increase the viscosity and/or gel stiffness of the dairy product

Dairy Product

A dairy product according to the invention may be any food product produced on the basis of one or more milk components. In a preferred embodiment of the invention a dairy product is produced on the basis of a dairy composition. A dairy product may additionally comprise non-milk components, e.g. vegetable components such as e.g. vegetable oil, vegetable protein, and/or vegetable carbohydrates. Dairy products may also comprise further additives such as e.g. enzymes, flavouring agents, microbial cultures, salts, sweeteners, sugars, acids, fruit, fruit juices, or any other component known in the art as a component of, or additive to, a dairy product. In a preferred embodiment the dairy product comprises probiotic cultures, i.e. cultures of living microorganisms, which upon ingestion by humans, exert health benefits beyond inherent basic nutrition. Probiotic cultures may e.g. comprise Bifidobacteria and/or Lactobacilli. A dairy product according to the invention may e.g. be skimmed milk, whole milk, cream, a fermented milk product, cheese, yoghurt, butter, dairy spread, butter milk, acidified milk drink, sour cream, whey based milk drink, ice cream, a flavoured milk drink, or a dessert product based on milk components such as e.g. via or custard.

In one embodiment of the invention a dairy composition accounts for at least 40% (weight/weight), such as at least 50%, e.g. at least 60%, preferably at least 70%, of the dairy product. In another embodiment of the invention one or more milk components and/or milk fractions account for at least 40% (weight/weight), such as at least 50%, e.g. at least 60%, preferably at least 70%, of the dairy product.

In a further embodiment the dairy product is not a powdered dairy product. A powdered dairy product is a dairy product wherein a substantial amount of water, i.e. more than 50% of the original water content of the milk, has been removed by drying and the product has been formed into a powder. Drying may be performed by any methods known in the art, such as e.g. evaporation, spray drying, drum drying, fluidised bed drying, freeze drying, or a combination of one or more methods. The drying process may lead directly to the formation of a powder such as is usually the case when spray drying, fluidised bed drying, and/or drum drying is used, or formation of a powder may be achieved by crushing, grinding or the like of the dried product. A powdered dairy product may be produced by drying the dairy product as such, and/or all or part of the water may be removed from one or more of the ingredients before all ingredients are mixed. In a preferred embodiment the dairy product has not been dried, i.e. less than 50% (weight/weight) of the milk components of the dairy product, has undergone drying.

Fermented Dairy Product

In a preferred embodiment of the invention the dairy product is a fermented dairy product. In the present context the term “fermented dairy product” is to be understood as any dairy product wherein any type of fermentation forms part of the production process. Examples of fermented dairy products are products like yoghurt, buttermilk, creme fraiche, quarg and fromage frais. A fermented dairy product may be produced by any method known in the art. In a preferred embodiment the dairy product is yoghurt.

In a preferred embodiment of the invention a fermented dairy product is produced by providing a dairy composition, as defined above. For fermentation the dairy composition is inoculated with a starter culture, which is chosen depending on the product to be produced.

Examples of starter cultures to be used according to the invention are lactic starter cultures, such as yoghurt cultures (Lactobacillus delbrueckii subsp. bulgaricus and Streptococcus thermophilus). Starter cultures may e.g. comprise Lactobacillus spp, e.g. Lactobacillus acidophilus and Lactobacillus delbrueckii subsp. lactis, Lactococcus spp, Streptococcus spp., Leuconostoc spp., and Bifidobacteria. Such cultures are readily available from e.g. Chr. Hansen A/S, Hørsholm, Denmark. However, any starter culture known in the art and suitable for producing a fermented dairy product may be used.

Doses of starter culture added and incubation temperatures vary depending e.g. on the culture and/or dairy composition used and the final product required. However, culture doses are often in the range equivalent to 0.005-0.05% frozen concentrate. The fermentation is often carried out at temperatures between 20 and 50° C. for about 30 minutes to 16 hours. In one embodiment the dairy composition is stirred or homogenised after fermentation. In another embodiment the dairy composition is heat treated after fermentation.

As a result of fermentation or acidification pH may be lowered. The pH of a fermented dairy product of the invention may e.g. be in the range 3.5-6.5, such as in the range 3.5-6, preferably in the range 3.5-5.

In one embodiment the invention relates to a fermented dairy product which is not a powdered dairy product.

Cheese

In a preferred embodiment the dairy product is cheese. In the present context, the term “cheese” refers to any kind of cheese such as e.g. natural cheese, cheese analogues and processed cheese. The cheese may be obtained by any suitable process known in the art, such as e.g. by enzymatic coagulation of a dairy composition with rennet, or by acidic coagulation of a dairy composition with food grade acid or acid produced by lactic acid bacteria growth. In one embodiment, the cheese manufactured by the process of the invention is rennet-curd cheese. Rennet is commercially available, e.g. as Naturen® (animal rennet), Chy-max® (fermentation produced chymosin), Microlant® (Microbial coagulant produced by fermentation), all from Chr. Hansen A/S, Hørsholm, Denmark. The dairy composition may be subjected to a conventional cheese-making process.

The cheese produced by the process of the present invention comprises all varieties of cheese, e.g. hard cheeses such as Chester, Danbo, Manchego, Saint Paulin, Cheddar, Monterey, Colby, Edam, Gouda, Muenster, Swiss type, Gruyere, Emmenthaler, Parmesan and Romano; pasta filata cheeses such as Mozzarella; processed cheese; white mould cheese such as Brie and Camembert; or blue mould cheeses such as Gorgonzola and Danish blue cheese. In a preferred embodiment the dairy product is fresh cheese such as e.g. Ricotta, Cream cheese, Neufchatel or Cottage cheese.

Processed cheese is preferably manufactured from cheese or cheese analogues by cooking and emulsifying the cheese, such as with emulsifying salts (e.g. phosphates and citrate). The process may further include the addition of spices/condiments.

The term “cheese analogues” refers to cheese-like products which contain fat, such as e.g. milk fat (e.g. cream or butter) or vegetable oil, as a part of the composition, and which further contain, as part of the composition, one or more non-milk constituents, such as e.g. a vegetable constituent (e.g. vegetable protein or vegetable oil).

If the dairy product of the invention is cheese, hyaluronic acid may e.g. be added before, simultaneously with, or after addition of rennet. If the dairy product is process cheese hyaluronic acid may e.g. be added before, during, or after cooking.

### EXAMPLES

### Example 1

Yoghurt Made With and Without Hyaluronic Acid

Materials

Hyaluronic acid from chicken combs (Hyaluronsan HA-F, Q. P. Corporation, Tokyo, Japan)

Yoghurt culture FD-DVS YC-380 (Chr. Hansen A/S, Hørsholm, Denmark)

Inoculation level 500 U/2500 I milk

Whole milk 3.5% fat

Sugar

Production of Yoghurt

Milk was poured into 200 ml bottles, pasteurised at 90° C. for 20 minutes, cooled to 43° C. and inoculated with yoghurt culture.

Stirred Yoghurt:

The milk was incubated in a waterbath at 43° C. until pH reached 4.55. The coagulum was broken and stirred with a hand stirrer until the yoghurt was smooth. After stirring the bottle was placed in cold water to cool the product to 25° C. During the cooling the product was stirred from time to time. The product was cooled to 8° C. in a refrigerator.

Set Yoghurt:

The milk was incubated in a water bath at 43° C. until pH reached 4.55 and put directly into a refrigerator at 8° C. for cooling.

Hyaluronic acid was blended with sugar (1:10) and added to the relevant samples either right before pasteurisation or after pasteurisation when the milk was cooled to 43° C., respectively.

Rheological Measurements

Viscosity and oscillation measurements were performed using a Stress Tech rheometer (Reologica, Lund, Sweden) with a coaxial measuring system (C25). The measurements were performed at 13° C.

Viscometry Test:

The viscometry tests were made by continuous shear, varying the shear rates from 0.2707-300 1/s in 21 steps. The shear rate was first increased and then decreased and the corresponding shear stress values were measured.

Mouth thickness was defined as the shear stress at shear rate 300 1/s. High shear stress corresponds to a high viscosity.

Oscillation Test:

The oscillation frequency was varied from 0.5 to 8 Hz in 5 steps within the linear viscoelastic range of the product. The stress was 0.6 Pa.

Gel stiffness was defined as the value of the complex modulus (G*) at 1 Hz.

Results

The results are shown in table 1. It is seen that both mouth thickness and gel stiffness are increased by the addition of hyaluronic acid in both set and stirred yoghurt.

TABLE 1
Mouth thickness (shear stress at a shear rate of 300 1/s)
and gel stiffness (complex modulus, G*, at an oscillation
frequency of 1 Hz) of yoghurt made with and without hyaluronic
acid.

| Hyaluronic | | | Mouth | |
|---|---|---|---|---|
| acid | Yoghurt | Amount of | thickness | Gel stiffness |
| addition | type | hyaluronic acid | (Pa) | (Pa) |
| After heat | Stirred | 0% | 32 | 131 |
| treatment | | 0.033% | 39 | 196 |
| | Set | 0% | 35 | 196 |
| | | 0.033% | 42 | 205 |
| Before heat | Stirred | 0% | 38 | 157 |
| treatment | | 0.033% | 41 | 243 |
| | Set | 0% | 46 | 220 |
| | | 0.033% | 46 | 261 |

### Example 2

Addition of Hyaluronic Acid to Milk

Materials

Hyaluronic acid from chicken combs (Hyaluronsan HA-F, Q. P. Corporation, Tokyo, Japan)

Sodium hyaluronate (topical use grade) produced by fermentation of Streptococcus (Shandong Freda Biochemical Co., Jinan, China).

1% solutions of hyaluronic acid in milk with 0.5% fat were made by dispersing hyaluronic acid in milk. The dispersions were stirred on magnetic stirrer over night at room temperature to dissolve the hyaluronic acid. Three 1% solutions were made for each hyaluronic acid type.

Viscometry and oscillation measurements were performed using a Stress Tech rheometer (Reologica, Lund, Sweden) with a coaxial measuring system (C25). The measurements were performed at 13° C.

Viscometry Test:

The viscosity tests were made by continuous shear, varying the shear rates from 6-300 1/s in 10 steps. The shear stress at a shear rate of 100 Hz is reported as a measure of the viscosity of the product.

Oscillation Test:

In the oscillation test the frequency was varied from 0.8-4 Hz in 4 steps within the linear viscoelastic range of the product. The stress at each step was 0.2 Pa, 0.6 Pa, 0.6 Pa, and 0.6 Pa respectively. The value of the complex modulus, G*, at 2 Hz was used as a measure of the gel stiffness.

Results

Shear stress at 100 1/s for milk without hyaluronic acid added was 0.2 Pa.

Results for samples with hyaluronic acid added are shown in table 2. It is seen that shear stress in the viscometry test is considerably increased compared to milk without hyaluronic acid for both types of hyaluronic acid.

TABLE 2
Shear stress measured with continuous shear at 100 1/s
and Gel stiffness, G*, measured
with oscillation at 2 Hz, for milk with hyaluronic acid.

| | Shear stress | Gel stiffness |
|---|---|---|
| Hyaluronic acid source | (Pa) | (Pa) |
| Chicken comb | 54.0 | 17.5 |
| | 61.5 | 22.8 |
| | 60.3 | 25.1 |
| Fermentation of | 107.2 | 111.5 |
| Streptococcus | 102.0 | 125.5 |
| | 109.5 | 118.1 |

### Example 3

Stirred Yoghurt With Hyaluronic Acid Added to Cold or Warm Milk

Milk with 0.5% fat was poured into 200 ml bottles. 0.02% hyaluronic acid (sodium hyaluronate from Streptococcus as in example 2) was dissolved in one bottle of milk (over night on magnetic stirrer). Another bottle was heated to 95° C. before mixing 0.02% hyaluronic acid into the milk with an ystral mixer (type X10/20, SRS Aps., Kolding, Denmark). As a control, milk without hyaluronic acid was added to a third bottle. The three samples were heat treated at 95° C. for 5 minutes and cooled to inoculation temperature. The three samples (2 with and 1 without hyaluronic acid) were inoculated with yoghurt culture as in example 1, and the milk was fermented at 43° C. until pH reached 4.55. The yoghurt was stirred with a hand stirrer until the yoghurt was smooth and cooled to 8° C. in a refrigerator. Rheological measurements were conducted as described in example 1 on all samples on the following day. The experiments were performed in triplicate. Results are shown in table 3.

TABLE 3
Mouth thickness (shear stress at a shear rate of 300 1/s) and gel
stiffness (compiex modulus, G*, at an oscillation
frequency of 1 Hz) of yoghurt made with hyaluronic acid
added to cold or warm milk compared
to yoghurt without hyaluronic acid.

| | Mouth thickness | Gel stiffness |
|---|---|---|
| | (Pa) | (Pa) |
| Yoghurt without hyaluronic acid | 32.7 | 87.5 |
| | 33.3 | 92.3 |
| | 30.2 | 98.3 |
| Yoghurt with hyaluronic acid | 41.2 | 106.0 |
| added to cold milk | 40.7 | 108.3 |
| | 39.8 | 116.9 |
| Yoghurt with hyaluronic acid | 42.5 | 228.6 |
| added to warm milk | 43.5 | 192.3 |
| | 44.4 | 282.8 |

1. A dairy product comprising hyaluronic acid and one or more milk components.

2. The dairy product of claim 1 wherein the amount of hyaluronic acid is 0.001-10% (weight/weight) of the dairy product.

3. The dairy product of claim 1 or wherein a dairy composition accounts for at least 40% (weight/weight) of the dairy product.

4. The dairy product of claim 1 wherein one or more milk components account for at least 40% (weight/weight) of the dairy product.

5. The dairy product of claim 1 characterised by being a fermented dairy product.

6. The dairy product of claim 1 characterised by being cheese.

7. The dairy product of claim 1 characterised by being ice cream.

8. The dairy product of claim 5 characterised by being yoghurt.

9. The dairy product of claim 1 which is not a powdered dairy product.

10. The dairy product of claim 1 wherein less than 50% (weight/weight) of the milk components of the dairy product, has undergone drying.

11. The dairy product of claim 1 wherein hyaluronic acid is produced by a microorganism.

12. A method for producing a dairy product according to any of the claim 1 comprising add-ing hyaluronic acid to a dairy composition.

13. (Cancelled)
